(19) United States
(12) Patent Application Publication
(10) Pub. No.: US 2005/0041706 A1
(43) Pub. Date: Feb. 24, 2005

(54) Laser driver circuit

(76) Inventor: Vikram Magoon, San Diego, CA (US)

Correspondence Address: INTEL CORPORATION, P.O. BOX 5326, SANTA CLARA, CA, 95056-5326, US

(21) Appl. No.: 10/645,143

(22) Filed: Aug. 20, 2003

(51) Int. Cl. H01S 3/00

(52) U.S. Cl. 372/38.02; 372/38.01

(57) ABSTRACT

Disclosed are a device, system and method for controlling a duty cycle of a pulse data signal. A pulse data output signal may be generated in response to an input signal where the pulse data output signal comprises a duty cycle. The duty cycle of the pulse data output signal may be adjusted based, at least in part, upon an approximation of the average power of the pulse data output signal.

### BACKGROUND

1. Field

The subject matter disclosed herein relates to techniques used in the transmission of data over an optical transmission medium.

2. Information

Data is typically transmitted over an optical transmission medium (e.g., fiber optic cabling) as pulses of light energy generated by a laser diode. Such a laser diode is typically powered by a current signal that is modulated by pulses of encoded data in a pulse data signal. Such a pulse data signal is typically generated as a series of symbols transmitted in signal periods. During a pulse period portion of each signal period, a pulse of energy, or absence of such a pulse, can indicate a symbol value being transmitted during the pulse period.

A pulse data signal is typically characterized as having a “duty cycle” which reflects a ratio of a pulse period to a signal period in the pulse data signal. Depending on a particular format, protocol or standard used for transmitting data in an optical transmission medium, a signal period in pulse data signal (used to modulated current signal for powering a laser diode) is typically tailored to have a duty cycle to conform to the particular format, protocol or standard.

FIG. 1 shows a prior art duty cycle control circuit 10 that may be used to control a duty cycle of a current signal to be used in powering a vertical cavity surface emitting laser (VCSEL). An output stage 14 generates a pulse data output signal in response to an input signal received at terminals 12. A duty cycle adjustment circuit 16 adjusts DC levels on differential terminals coupled to the output stage 14 to affect the duty cycle of the pulse data output signal. A mark-space monitor circuit 18 provides a voltage to an operational amplifier 20 which is representative of a DC voltage on differential terminals 24. A mark-space reference circuit 22 generates a voltage representative of a DC voltage on the differential terminals 24 at a 100% duty cycle. Resistances R1 and R2 may be selected to divide the voltage at the output of the mark-space reference circuit 22. The divided voltage and output of the mark-space monitor circuit 18 are received at input terminals of an operational amplifier 20. The output of the operational amplifier 20 is then provided to the duty cycle adjustment circuit 16 to affect the DC voltage on terminals 24.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a prior art duty cycle control circuit 10 that may be used to control a duty cycle of a current signal to be used in powering a vertical cavity surface emitting laser (VCSEL).

FIG. 2 shows a schematic diagram of a system to transmit data in and receive data from an optical transmission medium according to an embodiment of the present invention.

FIG. 3 shows a schematic diagram of physical medium attachment (PMA) and physical medium dependent (PMD) sections of a data transmission system according to an embodiment of the system shown in FIG. 3.

FIG. 4 shows a schematic diagram of a laser driver according to an embodiment of the PMD section shown in FIG. 3.

FIG. 5 shows a schematic diagram of a duty cycle control circuit according to an embodiment of the laser driver shown in FIG. 4.

FIG. 6A shows a diagram illustrating behavior of a differential signal for generating a pulse data signal having a duty cycle of about fifty percent according to an embodiment of the duty cycle control circuit shown in FIG. 5.

FIG. 6B shows a diagram illustrating timing characteristics of a pulse data output signal in response to the differential signal illustrated in FIG. 6A.

FIG. 7A shows a diagram illustrating behavior of a differential signal for generating a pulse data signal having a duty cycle of about sixty percent according to an embodiment of the duty cycle control circuit shown in FIG. 5.

FIG. 7B shows a diagram illustrating timing characteristics of a pulse data output signal in response to the differential signal illustrated in FIG. 7A.

FIG. 8 shows a differential amplifier according to an embodiment of the duty cycle control circuit shown in FIG. 5.

FIG. 9 shows a schematic diagram of an input stage amplifier according to an embodiment of the duty cycle control circuit shown in FIG. 5.

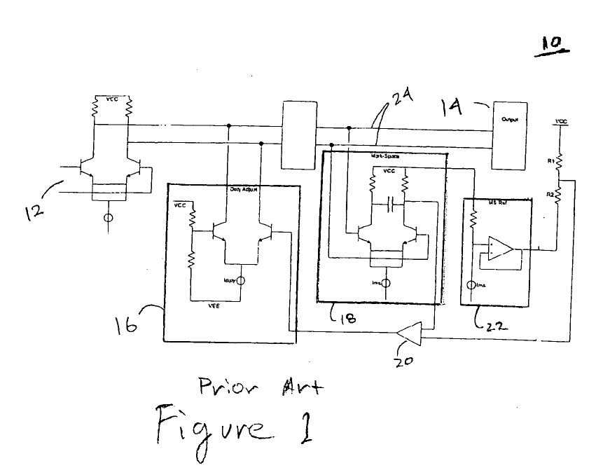

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions or data. Such storage devices may comprise storage media such as, for example, optical, magnetic or semiconductor storage media. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments of the present invention are not limited in this respect.

A “pulse data signal” as referred to herein relates to a signal that transmits energy according a pulsed signal profile. A pulse data signal may fluctuate between high and low energy states to represent information. For example, a pulse data signal may fluctuate over a “signal period” between a high signal voltage and a low signal voltage where transitions between the high and low signal voltages are approximately instantaneous in the signal period. In this example, pulse data signal may transmit a single bit in each signal period. In a portion of each signal period a “pulse period” may represent a one symbol (such as a “one”) by a presence of a high signal voltage pulse over the pulse period and another symbol (such as a “zero”) by a presence of a low signal voltage signal over the pulse period. However, these are merely examples of a pulse data signal and embodiments of the present invention are not limited in these respects.

A “duty cycle” as referred to herein relates to a relationship between a duration of a signal period and a duration of pulse period of a pulse data signal. A duty cycle may be expressed as percentage of the signal period duration that is covered by the pulse period. For example, a duty cycle of 50% may indicate that the pulse period extends over half of the signal period and a duty cycle of 25% may indicate that the pulse period extends over one fourth of the signal period.

An “average power” of a signal as referred to herein relates to the average power transmitted over a time period. A pulse data signal transmitting a high signal voltage in pulse periods (e.g., to represent a “one”) may transmit an average power that may vary according to a duty cycle associated with a pulse period. Such a pulse data signal, for example, may transmit a higher average power at higher duty cycles and a lower average power at lower duty cycles. However, this is merely an example of how an average power of a signal may be determined and embodiments of the present invention are not limited in this respect.

A “differential signal” as referred to herein relates to a signal that may be transmitted over a pair of conducting terminals. A differential signal may comprise a voltage signal having a magnitude that is modulated by information. For example, a differential signal may comprise a voltage signal across a pair of conducting terminals. However, these are merely examples of a differential signal and embodiments of the present invention are not limited in these respects.

Briefly, embodiments of the present invention relate to a device and method for controlling a duty cycle of a pulse data signal. A pulse data output signal may be generated in response to an input signal where the pulse data output signal comprises a duty cycle. The duty cycle of the pulse data output signal may be adjusted based, at least in part, upon an approximation of the average power of the pulse data output signal. However, this is merely an example embodiment and other embodiments are not limited in these respects.

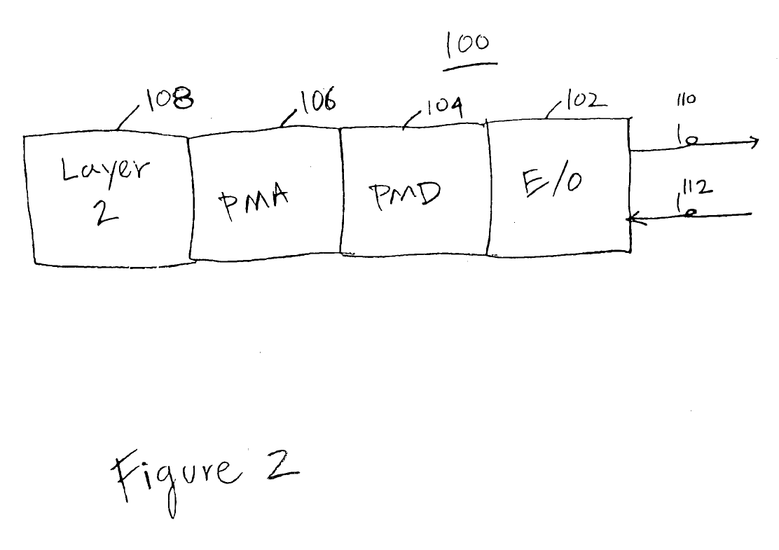

FIG. 2 shows a schematic diagram of a system to transmit in and receive data from an optical transmission medium according to an embodiment of the present invention. An optical transceiver 102 may transmit or receive optical signals 110 or 112 in an optical transmission medium such as fiber optic cabling. The optical transceiver 102 may modulate the transmitted signal 110 or demodulate the received signal 112 according to any optical data transmission format such as, for example, wave division multiplexing wavelength division multiplexing (WDM) or multi-amplitude signaling (MAS). For example, a transmitter portion (not shown) of the optical transceiver 102 may employ WDM for transmitting multiple “lanes” of data in the optical transmission medium.

A physical medium dependent (PMD) section 104 may provide circuitry, such as a TIA (not shown) and/or limiting amplifier (LIA) (not shown), to receive and condition an electrical signal from the optical transceiver 102 in response to the received optical signal 112. The PMD section 104 may also provide to a laser device (not shown) in the optical transceiver 102 power from a laser driver circuit (not shown) for transmitting an optical signal. A physical medium attachment (PMA) section 106 may include clock and data recovery circuitry (not shown) and de-multiplexing circuitry (not shown) to recover data from a conditioned signal received from the PMD section 104. The PMA section 106 may also comprise multiplexing circuitry (not shown) for transmitting data to the PMD section 104 in data lanes, and a serializer/deserializer (Serdes) for serializing a parallel data signal from a layer 2 section 108 and providing a parallel data signal to the layer 2 section 108 based upon a serial data signal provided by the clock and data recovery circuitry.

According to an embodiment, the layer 2 section 108 may comprise a media access control (MAC) device coupled to the PMA section 106 at a media independent interface (MII) as defined IEEE Std.802.3ae-2002, clause 46. In other embodiments, the layer 2 section 108 may comprise forward error correction logic and a framer to transmit and receive data according to a version of the Synchronous Optical Network/Synchronous Digital Hierarchy (SONET/SDH) standard published by the International Telecommunications Union (ITU). However, these are merely examples of layer 2 devices that may provide a parallel data signal for transmission on an optical transmission medium, and embodiments of the present invention are not limited in these respects.

The layer 2 section 108 may also be coupled to any of several input/output (I/O) systems (not shown) for communication with other devices on a processing platform. Such an I/O system may include, for example, a multiplexed data bus coupled to a processing system or a multi-port switch fabric. The layer 2 section 108 may also be coupled to a multi-port switch fabric through a packet classification device. However, these are merely examples of an I/O system which may be coupled to a layer 2 device and embodiments of the present invention are not limited in these respects.

The layer 2 device 108 may also be coupled to the PMA section 106 by a backplane interface (not shown) over a printed circuit board. Such a backplane interface may comprise devices providing a 10 Gigabit Ethernet Attachment Unit Interface (XAUI) as provided in IEEE Std.802.3ae-2002, clause 47. In other embodiments, such a backplane interface may comprise any one of several versions of the System Packet Interface (SPI) as defined by the Optical Internetworking Forum (OIF). However, these are merely examples of a backplane interface to couple a layer 2 device to a PMA section and embodiments of the present invention are not limited in these respects.

FIG. 3 shows a schematic diagram of a system 200 to transmit data in and receive data from an optical transmission medium according to an embodiment of the system shown in FIG. 2. An optical transceiver 202 comprises a laser device 208 to transmit an optical signal 210 in an optical transmission medium and a photo detector section 214 to receive an optical signal 212 from the optical transmission medium. The photo detector section 214 may comprise one or more photodiodes (not shown) for converting the received optical signal 212 to one or more electrical signals to be provided to a transimpedance amplifier/limiting amplifier (TIA/LIA) circuit 220. A laser driver circuit 222 may modulate a current signal 216 in response to a data signal from a PMA section 232. A laser device 208 may then modulate and power the transmitted optical signal 210 in response to the current signal 216.

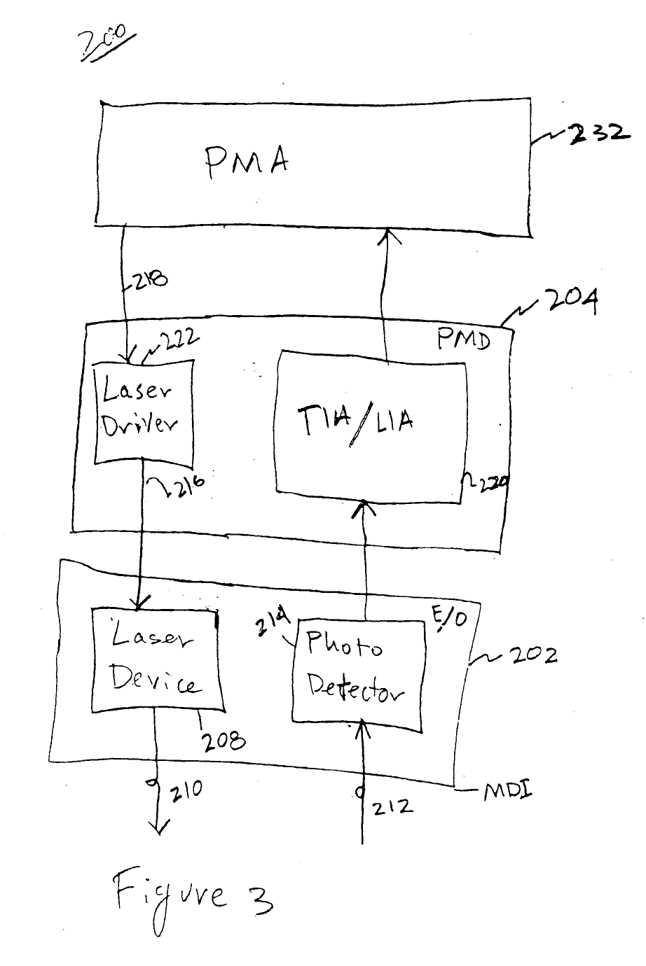

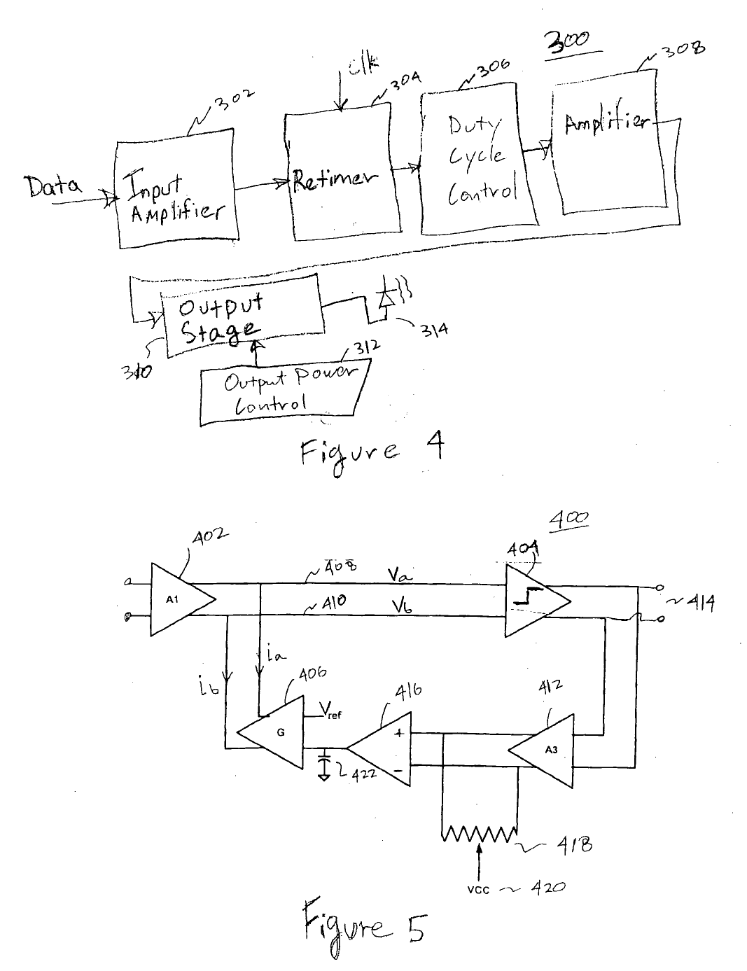

FIG. 4 shows a schematic diagram of a laser driver 300 according to an embodiment of the PMD section shown in FIG. 3. Data may be received from a PMA section at an input amplifier 302 as a stream of binary symbols such as “ones” and “zeros.” The binary symbols may be expressed as a bi-level signal. A retimer circuit 304 may adjust the temporal spacing of the binary symbols in response to a clock signal. A duty cycle control circuit 306 may provide a pulse data output signal to an amplifier 308 in response to the retimed binary stream. While input amplifier 302 and retimer circuit 304 are indicated as being part of a PMD section, it should be recognized that such an input amplifier and retimer circuit may be provided in a PMA section coupled to a PMD section including a laser driver circuit. An output stage circuit 310 may provide a current signal to drive a laser diode 314 in response to an amplified pulse data output signal from the amplifier 308, and based upon set levels for a bias current and modulation current determined from an output power control circuit 312.

FIG. 5 shows a schematic diagram of a duty cycle control circuit 400 according to an embodiment of the laser driver shown in FIG. 4. The duty cycle control circuit 400 may be formed in a single semiconductor device or multiple semiconductor devices. Alternatively, the duty cycle control circuit 400 may include one or more “off-chip” components which are coupled to devices formed in a semiconductor device. In response to receipt of a binary symbol stream from a retimer circuit at input terminals, an amplifier 402 may generate a differential voltage (Vₐ and V_{b}) on output terminals 408 and 410. A hard limiting circuit or limiting amplifier 404 may generate a pulse data output signal on differential terminals 414 in response to the differential voltage Vₐ−V_{b}. A current steering device 406 may affect the duty cycle of the pulse data output signal by drawing current from or adding current to the output terminals 408 (drawing or adding current iₐ) and 410 (drawing or adding current i_{b}). For example, the current steering device 406 may cause a “current skew” in which the current steering device draws an amount of current from one output terminal 408 or 410 and adds the drawn current to the other output terminal. However, this is merely an example of how a current steering device may be used to adjust a duty cycle of a pulse data output signal and embodiments of the present invention are not limited in this respect.

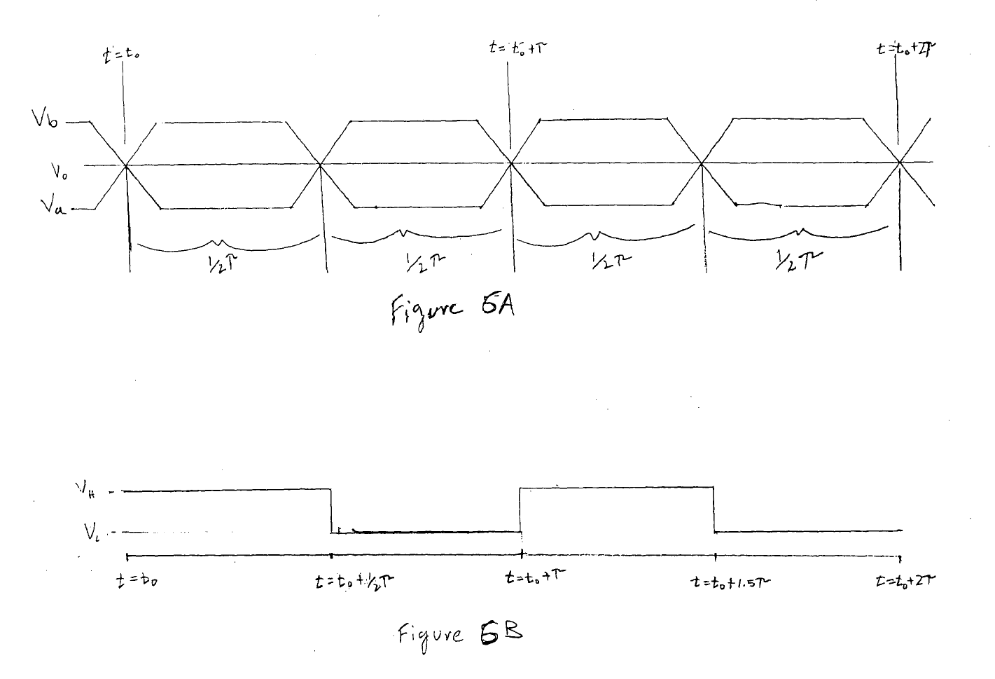

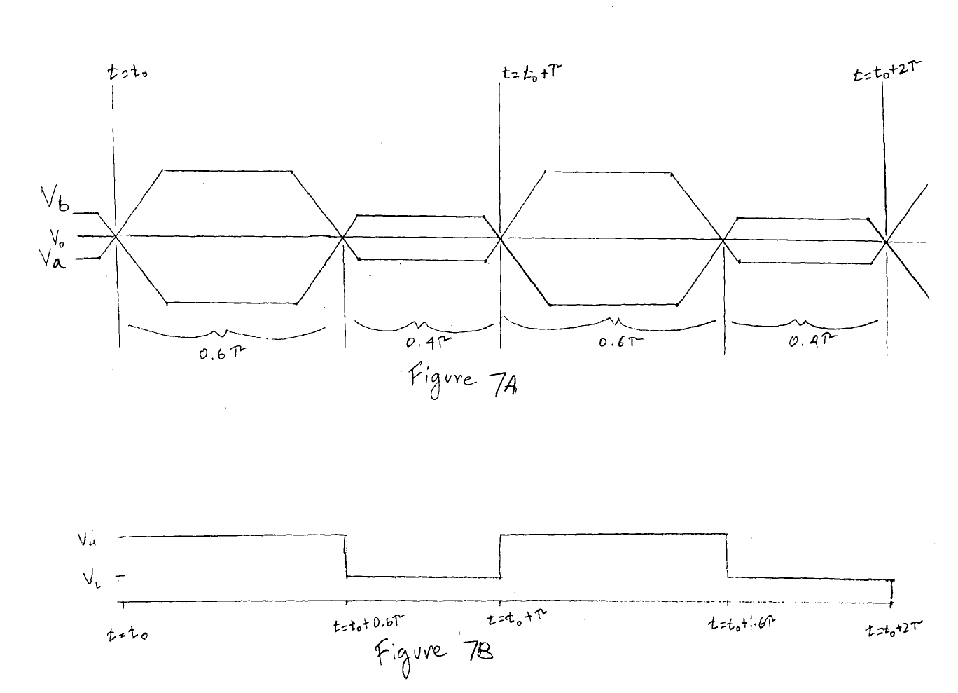

FIGS. 6A through 7B illustrate how the current steering device 406 may affect the duty cycle of the pulse data output signal by adding current to or drawing current from the terminals 408 and 410 according to embodiments of the duty cycle control circuit 400. A binary symbol (e.g., a “one” or “zero”) may be transmitted during each signal period τ. For simplicity, it will be assumed that a binary “one” is being transmitted on each signal period τ such that the hard limiting circuit 404 may generate a high signal voltage during the pulse period in each signal period τ. However, it should be understood that a stream of binary signals may comprise randomly mixed “one” and “zero” symbols. The length of a pulse period within a signal period τ may be determined by the duration that Vₐ−V_{b} exceeds a threshold voltage Vₒ in response to a binary symbol of “one” during the symbol period τ. Accordingly, hard limiting circuit 404 may generate a set high signal voltage on terminals 414 when Vₐ−V_{b} exceeds a threshold voltage Vₒ.

FIG. 6A shows a diagram illustrating behavior of a differential signal across the terminals 408 and 410 for generating a pulse data signal having a duty cycle of about fifty percent. The current steering device 406 may set iₐ and i_{b} such that Vₐ−V_{b} exceeds the threshold voltage Vₒ over about half of the signal period τ in response to a “one,” resulting in a pulse period that extends over half the signal period τ and resulting in a duty cycle of about fifty percent. FIG. 6B illustrates the timing of a pulse data output signal generated in response to the differential signal illustrated in FIG. 6A. A pulse period extends over 1/2 τ during which the pulse data output signal has a high signal voltage V_{H}. Over the remaining portion of the signal period, the pulse data output signal drops to a low signal voltage V_{L}.

FIG. 7A shows a diagram illustrating behavior of a differential signal for generating a pulse data signal having a duty cycle of about sixty percent. The current steering device 406 may set iₐ and i_{b} such that Vₐ−V_{b} exceeds the threshold voltage Vₒ over about sixty percent of the signal period τ in response to a “one,” resulting in a pulse period that extends over half the signal period τ and resulting in a duty cycle of about sixty percent. FIG. 7B illustrates the timing of a pulse data output signal generated in response to the differential signal illustrated in FIG. 7A. A pulse period extends over 0.6τ during which the pulse data output signal has a high signal voltage V_{H}. Over the remaining portion of the signal period, the pulse data output signal drops to a low signal voltage V_{L}. It should be understood that FIGS. 6A through 7B merely illustrate examples of how the current steering device 406 may adjust a duty cycle to be at about fifty percent and sixty percent, and that the current steering device 406 may adjust a duty cycle to be less than fifty percent or greater than sixty percent.

According to an embodiment, the current steering device 406 may respond to an approximation of the average power of the pulse data output signal provided on terminals 414. In the presently illustrated embodiment, it is assumed that the pulse data output signal may transmit either a “one” or “zero” with equal likelihood. Accordingly, during a pulse period on any signal period, the pulse data output signal may be at the high signal voltage or the low signal voltage with equal likelihood. A differential amplifier 412 may receive the pulse data output signal and provide a differential voltage to inverting and non-inverting input terminals of an operational amplifier 416.

A capacitor 422 may be coupled to a first input terminal of the current steering device 406 and an output terminal of the operational amplifier 416. The capacitor 422 may receive and integrate an amplified signal from the output terminal of the operational amplifier 416 to maintain a voltage at the first input terminal of the current steering device 406 that represents the average power approximation (i.e., of the pulse data output signal). In response to a difference between a voltage at the first input terminal and a reference voltage V_{ref} at a second input terminal of the current steering device 406, the current steering device 406 may adjust the currents iₐ and i_{b} to adjust or maintain the duty cycle of the pulse data output signal as described above.

According to an embodiment, the capacitor 422 may be sized to stabilize the loop based upon a maximum frequency associated with the pulse data output signal (e.g., up to 10, 40 or 100 gigahertz). Additionally, the capacitor 422 may be coupled to the current steering device 406 and operational amplifier 416 as an off-chip capacitor.

According to an embodiment, a potentiometer 418 may be used to allocate a resistance between a voltage source V_{cc} and output terminals of the differential amplifier 412. By setting the potentiometer 418, the gain of the differential amplifier 412 may be increased or decreased, causing a corresponding increase or decrease in the voltage provided to the current steering device 406 from the operational amplifier 416. While the duty cycle control circuit 400 may be formed in a single semiconductor device, in one embodiment, the potentiometer 418 may comprise an off-chip device that may be manually set to affect the duty cycle of the pulse output data signal.

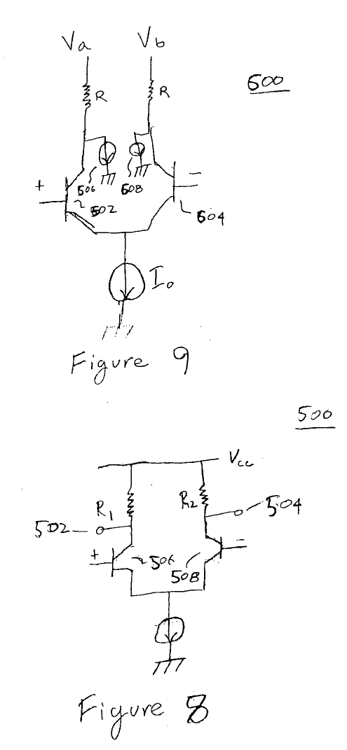

FIG. 8 shows a differential amplifier 500 according to an embodiment of the differential amplifier 412 shown in FIG. 5. The differential amplifier 500 may receive a pulse data output signal as a differential signal applied to base terminals of transistors 506 and 508, and provide a differential output signal (e.g., to operational amplifier 416) at output terminals 502 and 504. In alternative embodiments of a differential amplifier, the pulse data output signal may be received at base terminals of bipolar transistors providing an output voltage at differential output terminals. Regardless of whether field effect transistors or bipolar transistors are used to form the differential amplifier 412, the transistors may be formed to respond to the pulse data output signal at the intended operating frequencies (e.g., 10, 40 or 100 gigahertz) to enable accurate approximation of the average power at capacitor 422.

Resistances R₁ and R₂ may represent resistances allocated between the voltage source V_{cc} and each of the output terminals 502 and 504 to affect the gain of the differential amplifier 500. For example, a potentiometer (e.g., potentiometer 418) may be settable to allocate a total resistance of R_{T} (where R₁+R₂=R_{T} in the presently illustrated embodiment) between the voltage source V_{cc} and each of the output terminals 502 and 504. Terminals of the total resistance R_{T} may each be coupled to a corresponding output terminal of the differential amplifier 412 and the potentiometer 48 may be settable to position the voltage source V_{cc} at a location between terminals of the total resistance R_{T}.

FIG. 9 shows a schematic diagram of an input stage amplifier 600 according to an embodiment of the input stage amplifier 402 shown in FIG. 5. A differential data input signal may be receive at base terminals of bipolar transistors 602 and 604 to conduct portions of a tail current Iₒ across resistors R and provide the voltages Vₐ and V_{b} on differential output terminals (e.g., differential terminals 408 and 410). Current sources 606 and 608 may model currents iₐ and i_{b} which are controlled by the current steering device 406 to skew currents on terminals 408 and 410 as described above. In the currently illustrated embodiment, the tail current Iₒ may set such that the current skew (i.e., iₐ−i_{b}) does not exceed the tail current Iₒ.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

1. A laser driver circuit comprising:
an input stage to receive an input signal;
a limiting amplifier to generate a pulse data output signal in response to the input signal, the pulse data output signal comprising a duty cycle;
an output stage to modulate an output current signal based upon the pulse data output signal; and
a duty cycle control circuit to control the duty cycle of the pulse data output signal based, at least in part, on an approximation of an average power of the pulse data output signal.

2. The laser driver circuit of claim 1, wherein the input signal comprises a bi-level signal.

3. The laser driver circuit of claim 1, wherein the input stage generates a differential signal on first and second terminals coupled to the limiting amplifier, and wherein the duty cycle control circuit comprises a current steering circuit to apply an offset current to at least one of the first and second terminals in response to the approximation of the average power of the pulse data output signal.

4. The laser driver circuit of claim 1, wherein the duty cycle control circuit further comprises a potentiometer settable to adjust the duty cycle of the pulse data output signal.

5. The laser driver circuit of claim 4, wherein the duty cycle control circuit further comprises a differential amplifier to generate a differential voltage on first and second terminals in response to the pulse data output signal, and wherein the potentiometer is coupled to the differential amplifier to determine a resistance between a voltage source and at least one of the first and second terminals to affect the differential voltage.

6. The laser driver circuit of claim 5, wherein the potentiometer is settable to allocate a resistance coupled between the voltage source and each of the first and second terminals.

7. A method comprising:
generating a pulse data output signal in response to an input signal, the pulse data output signal comprising a duty cycle;
controlling the duty cycle of the pulse data output signal based, at least in part, upon an approximation of the average power of the pulse data output signal.

8. The method of claim 7, wherein the method further comprises:
generating a differential signal on first and second terminals in response to the input signal; and
applying an offset current to at least one of the first and second terminals in response to the approximation of the average power of the pulse data output signal.

9. The method of claim 7, wherein the method further comprises setting a potentiometer to adjust the duty cycle of the pulse data output signal.

10. The method of claim 9, wherein the method further comprises:
generating a differential voltage on first and second terminals in response to the pulse data output signal; and
setting the potentiometer to determine a resistance between a voltage source and at least one of the first and second terminals to affect the differential voltage.

11. The method of claim 10, wherein the method further comprises setting the potentiometer to allocate a resistance coupled between the voltage source and each of the first and second terminals.

12. A system comprising:
a serializer to provide a serial data signal in response to a parallel data signal;
a laser device adapted to be coupled to an optical transmission medium to transmit an optical signal in the optical transmission medium in response to a current signal; and
a laser driver circuit comprising:
an input stage to receive an input signal;
a limiting amplifier to generate a pulse data output signal in response to the input signal, the pulse data output signal comprising a duty cycle;
an output stage to modulate the current signal based upon the pulse data output signal; and
a duty cycle adjustment circuit to adjust the duty cycle of the pulse data output signal based, at least in part, on an approximation of an average power of the pulse data output signal.

13. The system of claim 12, the system further comprising a SONET framer to provide the parallel data signal.

14. The system of claim 13, wherein the system further comprises a switch fabric coupled to the SONET framer.

15. The system of claim 13, the system further comprising an Ethernet MAC to provide the parallel data signal at a media independent interface.

16. The system of claim 15, wherein the system further comprises a multiplexed data bus coupled to the Ethernet MAC.

17. The system of claim 15, wherein the system further comprises a switch fabric coupled to the Ethernet MAC.
